(19) United States
(12) Patent Application Publication
(10) Pub. No.: US 2026/0245498 A1
(43) Pub. Date: Aug. 20, 2026

(54) PIXEL CIRCUIT, DISPLAY DEVICE INCLUDING THE PIXEL CIRCUIT AND ELECTRONIC DEVICE INCLUDING THE PIXEL CIRCUIT

(71) Applicant: Samsung Display Co., LTD., Yongin-si (KR)

(72) Inventors: YEONKYUNG KIM, Yongin-si (KR); KYUNG-BAE KIM, Yongin-si (KR); DONGWOO KIM, Yongin-si (KR); YONGHEE LEE, Yongin-si (KR)

(21) Appl. No.: 19/366,839

(22) Filed: Oct. 23, 2025

(30) Foreign Application Priority Data
Feb. 18, 2025 (KR) 10-2025-0020491

(51) Int. Cl. G09G 3/32

(52) U.S. Cl. CPC G09G 3/32; G09G 2300/0819; G09G 2300/0852; G09G 2300/0861; G09G 2310/061; G09G 2310/08; G09G 2320/0238; G09G 2320/04; G09G 2380/10

(57) ABSTRACT

A pixel circuit includes a first transistor including a control electrode connected to a first node, a first electrode connected to a second node and a second electrode connected to a third node, a second transistor applying a data voltage to the first node, a third transistor applying a first power voltage to the second node in response to an emission signal, a fourth transistor connecting the third node and a fourth node in response to a reset signal, a fifth transistor applying an initialization voltage to the fourth node, and a light emitting element including a first electrode connected to the fourth node. The emission signal toggles between a first voltage level and a second voltage level. The reset signal toggles between a third voltage level and a fourth voltage level. The third voltage level is lower than the first voltage level.

This application claims priority to Korean Patent Application No. 10-2025-0020491, filed on February 18, 2025, and all the benefits accruing therefrom under 35 U.S.C. §119, the content of which in its entirety is herein incorporated by reference.

### BACKGROUND

### 1. Field

Embodiments of the present invention relate to a pixel circuit and a display device including the same. More particularly, embodiments of the present invention relate to a pixel circuit improving an emission reliability and a display device including the same.

### 2. Description of the Related Art

Generally, a display device includes a display panel and a display panel driver. The display panel includes a plurality of gate lines, a plurality of data lines, a plurality of emission lines and a plurality of pixels. The display panel driver includes a gate driver providing a gate signal to the gate lines, a data driver providing a data voltage to the data lines, an emission driver providing an emission signal to the emission lines and a driving controller controlling the gate driver, the data driver and the emission driver.

Recently, a display device which provide virtual reality (VR) or augmented reality (AR) have been gaining prominence. For this purpose, a display apparatus is desirable to have a low area and high integration. In this case, since a pitch occupied by the pixel circuit is narrowed, the number of transistors of the pixel circuit and the number of signals applied to the pixel circuit may have restriction.

### SUMMARY

Embodiments of the present invention provide a pixel circuit in which an emission reliability is improved.

Embodiments of the present invention provide a display device including the pixel circuit.

Embodiments of the present invention provide an electronic device including the pixel circuit.

According to embodiments, a pixel circuit includes: a first transistor including a control electrode connected to a first node, a first electrode connected to a second node and a second electrode connected to a third node, a second transistor configured to apply a data voltage to the first node in response to a write gate signal, a third transistor configured to apply a first power voltage to the second node in response to an emission signal, a fourth transistor configured to connect the third node and a fourth node in response to a reset signal, a fifth transistor configured to apply an initialization voltage to the fourth node in response to a bias signal and a light emitting element including a first electrode connected to the fourth node and a second electrode for receiving a second power voltage. The emission signal toggles between a first voltage level and a second voltage level. The first voltage level is higher than the second voltage level. The reset signal toggles between a third voltage level and a fourth voltage level. The third voltage level is higher than the fourth voltage level. The third voltage level is lower than the first voltage level.

In an embodiment, the third voltage level may be a voltage such that the fourth transistor is weakly turned on.

In an embodiment, in an emission period in which the light emitting element emits, the fourth transistor may be weakly turned on.

In an embodiment, in the emission period in which the light emitting element emits, the fourth transistor may operate in a linear region.

In an embodiment, a frame period in which the pixel circuit is driven may include an initialization period, a write period following the initialization period, and an emission period following the write period. In the initialization period, the reset signal may have the fourth voltage level, the emission signal may have the second voltage level and the bias signal may have an activation level.

In an embodiment, in the initialization period, the fourth transistor may be turned on, and the fifth transistor may be turned on.

In an embodiment, in in the write period following the initialization period, the emission signal may be changed from the second voltage level to the first voltage level, the reset signal may have the third voltage level, and the write gate signal may have an activation level.

In an embodiment, in emission period following the write period, the emission signal may have the second voltage level, and the reset signal may have the third voltage level.

In an embodiment, a frame period in which the pixel circuit is driven may include a first to sixth periods. In the first period, the emission signal may have the second voltage level, the bias signal may have an activation level, and the reset signal may have the fourth voltage level.

In an embodiment, in the second period following the first period, the emission signal may be changed from the second voltage level to the first voltage level, the bias signal may have the activation level, and the reset signal may have the third voltage level.

In an embodiment, in the third period following the second period, the emission signal may have the first voltage level, the bias signal may have the activation level, and the write gate signal may have an activation level.

In an embodiment, in the fourth period following the third period, the bias signal may have the activation level, and the write gate signal may have an inactivation level.

In an embodiment, in the fifth period following the fourth period, the bias signal may have an inactivation level.

In an embodiment, in the sixth period following the fifth period, the emission signal may have the second voltage level, and the reset signal may have the third voltage level.

In an embodiment, the second transistor may include a control electrode, which receives the write gate signal, a first electrode, which receives the data voltage and a second electrode connected to the first node. The third transistor may include a control electrode, which receives the emission signal, a first electrode, which receives the first power voltage and a second electrode connected to the second node. The fourth transistor may include a control electrode, which receives the emission signal, a first electrode connected to the third node and a second electrode connected to the fourth node. The fifth transistor may include a control electrode, which receives the bias signal, a first electrode, which receives the initialization voltage and a second electrode connected to the fourth node.

In an embodiment, the pixel circuit may further include a first capacitor including a first electrode connected to the second node and a second electrode connected to the first node and a second capacitor including a first electrode connected to the first node and a second electrode, which receives a reference voltage.

In an embodiment, the reference voltage may be the initialization voltage.

According to embodiments, a display device includes a display panel including a pixel circuit, a gate driver configured to output a gate signal including a write gate signal to the pixel circuit, an emission driver configured to output an emission signal to the pixel circuit, a data driver configured to apply a data voltage to the pixel circuit and a driving controller configured to control the gate driver, the emission driver and the data driver. The pixel circuit includes a first transistor including a control electrode connected to a first node, a first electrode connected to a second node and a second electrode connected to a third node, a second transistor configured to apply the data voltage to the first node in response to the write gate signal, a third transistor configured to apply a first power voltage to the second node in response to the emission signal, a fourth transistor configured to connect the third node and a fourth node in response to a reset signal, a fifth transistor configured to apply an initialization voltage to the fourth node in response to a bias signal and a light emitting element including a first electrode connected to the fourth node and a second electrode, which receives a second power voltage. The emission signal toggles between a first voltage level and a second voltage level. The first voltage level is higher than the second voltage level. The reset signal toggles between a third voltage level and a fourth voltage level. The third voltage level is higher than the fourth voltage level. The third voltage level is lower than the first voltage level.

In an embodiment, the third voltage level may be a voltage such that the fourth transistor is weakly turned on.

According to embodiments, an electronic device includes a display panel including a pixel circuit, a gate driver configured to output a gate signal including a write gate signal to the pixel circuit, an emission driver configured to output an emission signal to the pixel circuit, a data driver configured to apply a data voltage to the pixel circuit, a driving controller configured to control the gate driver, the emission driver and the data driver based on an input control signal and a processor configured to output the input control signal. The pixel circuit includes a first transistor including a control electrode connected to a first node, a first electrode connected to a second node and a second electrode connected to a third node, a second transistor configured to apply the data voltage to the first node in response to the write gate signal, a third transistor configured to apply a first power voltage to the second node in response to the emission signal, a fourth transistor configured to connect the third node and a fourth node in response to a reset signal, a fifth transistor configured to apply an initialization voltage to the fourth node in response to a bias signal and a light emitting element including a first electrode connected to the fourth node and a second electrode, which receives a second power voltage. The emission signal toggles between a first voltage level and a second voltage level. The first voltage level is higher than the second voltage level. The reset signal toggles between a third voltage level and a fourth voltage level. The third voltage level is higher than the fourth voltage level. The third voltage level is lower than the first voltage level.

As described above, a reset signal may toggle between a third voltage level and a fourth voltage level. Since the reset signal may have the fourth voltage level in an initialization period, a load transistor may be turned on (e.g., strongly turned on) in the initialization period. Accordingly, a reliability of an initialization operation in which a second electrode of a driving transistor is initialized as an initialization voltage may be improved. Accordingly, an emission reliability of the pixel circuit may be effectively improved. Additionally, since the load transistor may be weakly turned on in response to the reset signal, a black characteristic of the pixel circuit may be effectively improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the present invention.

FIG. 2 is a circuit diagram illustrating an example of a pixel circuit included in a display device of FIG. 1.

FIG. 3 is a timing diagram illustrating an example of signal applied to a pixel circuit of FIG. 2.

FIG. 4 is a circuit diagram illustrating an operation of a pixel circuit of FIG. 2 in a first period of FIG. 3.

FIG. 5 is a circuit diagram illustrating an operation of a pixel circuit of FIG. 2 in a second period of FIG. 3.

FIG. 6 is a circuit diagram illustrating an operation of a pixel circuit of FIG. 2 in a third period of FIG. 3.

FIG. 7 is a circuit diagram illustrating an operation of a pixel circuit of FIG. 2 in a fourth period of FIG. 3.

FIG. 8 is a circuit diagram illustrating an operation of a pixel circuit of FIG. 2 in a fifth period of FIG. 3.

FIG. 9 is a circuit diagram illustrating an operation of a pixel circuit of FIG. 2 in a sixth period of FIG. 3.

FIG. 10 is a circuit diagram illustrating an example of a pixel circuit included in a display device of FIG. 1.

FIG. 11 is a diagram illustrating an example of a pixel circuit included in a display device of FIG. 1 is located on a substrate.

FIG. 12 is a block diagram illustrating an electronic device according to embodiments of the present invention.

FIG. 13 to FIG. 15 are schematic diagrams illustrating an electronic device according to embodiments.

### DETAILED DESCRIPTION

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

It will be understood that when an element is referred to as being “connected to” another element, it can be directly connected to the other element or intervening elements may be present therebetween. In contrast, when an element is referred to as being “directly connected to” another element, there are no intervening elements present.

Hereinafter, the present invention will be explained in detail with reference to the accompanying drawings.

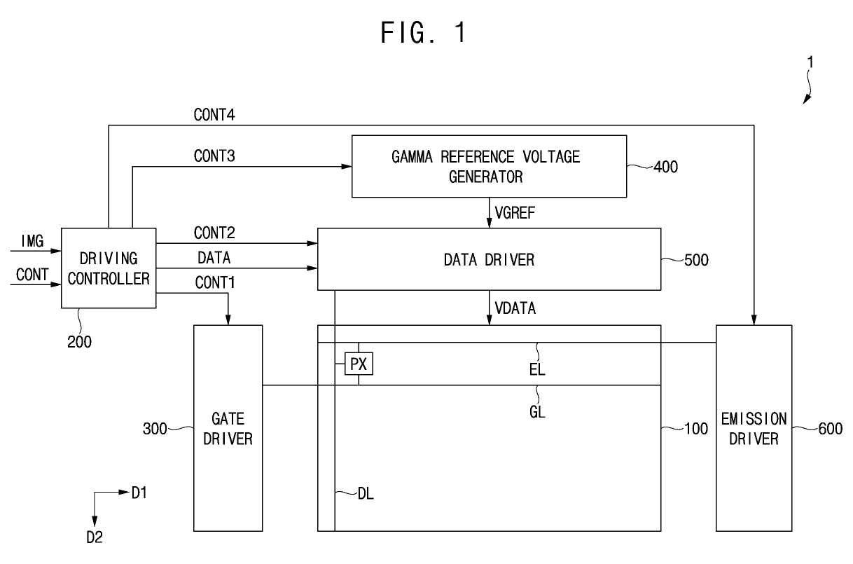

FIG. 1 is a block diagram illustrating a display device 1 according to embodiments of the present invention.

Referring to FIG. 1, an embodiment of the display device 1 includes a display panel 100 and a display panel driver. The display panel driver includes a driving controller 200, a gate driver 300, a gamma reference voltage generator 400, a data driver 500 and an emission driver 600.

The display panel 100 includes a display region on which an image is displayed and a peripheral region adjacent to the display region.

The display panel 100 includes a plurality of gate lines GL, plurality of emission lines EL, a plurality of data lines DL and a plurality of pixels electrically connected to the gate lines GL, the emission lines EL and the data lines DL. The gate lines GL may extend in a first direction D1, the emission lines EL may extend in the first direction D1 and the data lines DL may extend in a second direction D2 crossing the first direction D1.

The driving controller 200 receives input image data IMG and an input control signal CONT from an external apparatus. In an embodiment, for example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, a fourth control signal CONT4 and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The driving controller 200 generates the fourth control signal CONT4 for controlling an operation of the emission driver 600 based on the input control signal CONT, and outputs the fourth control signal CONT4 to the emission driver 600.

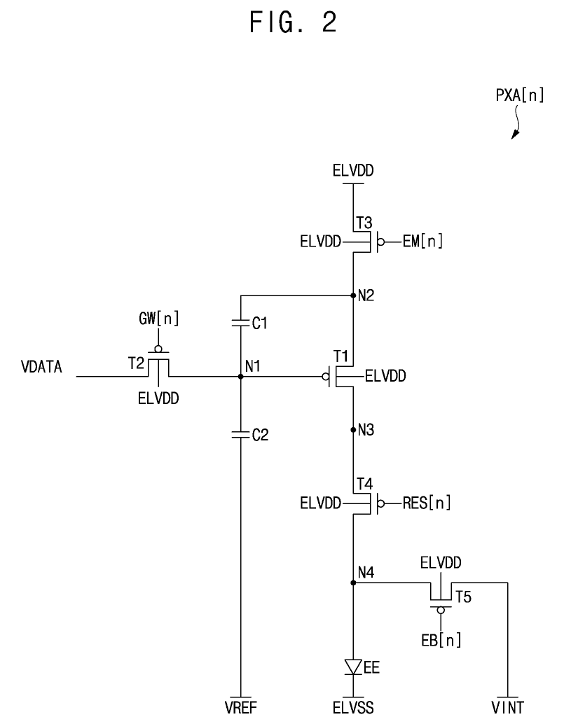

The gate driver 300 generates gate signals driving the gate lines GL in response to the first control signal CONT1 received from the driving controller 200. The gate driver 300 may output the gate signals to the gate lines GL. For example, the gate signals may include a write gate signal GW[n] of FIG. 2, a reset signal RES[n] of FIG. 2 and a bias signal EB[n] of FIG. 2.

In an embodiment, the gate driver 300 may be disposed in the peripheral region. In an embodiment, the gate driver 300 may be integrated in the peripheral region.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages VDATA having an analog type using the gamma reference voltages VGREF. The data driver 500 outputs the data voltages VDATA to the data lines DL.

The emission driver 600 may generate emission signal EM[n] of FIG. 2 in response to the fourth control signal CONT4 received from the driving controller 200. The emission driver 600 may output the emission signal EM[n] of FIG. 2 to the display panel 100.

In an embodiment, the emission driver 600 may be disposed in the peripheral region. In an embodiment, the emission driver 600 may be integrated in the peripheral region.

Although an embodiment where the gate driver 300 is disposed on a first side of the display panel 100, and the emission driver 600 is disposed on a second side of the display panel 100 is shown in FIG. 1 for convenience of illustration and description, the invention is not limited thereto. In another embodiment, the gate driver 300 and the emission driver 600 may be disposed on the first side of the display panel 100. In an embodiment, for example, the gate driver 300 and the emission driver 600 may be disposed on the peripheral region of the display panel 100 on a same side of the display region of the display panel 100. In an embodiment, for example, the gate driver 300 and the emission driver 600 may be formed integrally with each other as a single chip.

FIG. 2 is a circuit diagram illustrating an example of a pixel circuit PX included in a display device 1 of FIG. 1.

Referring to FIG. 1 and FIG. 2, a pixel circuit PXA[n] may include a first transistor T1, a second transistor T2, a third transistor T3, a fourth transistor T4, a fifth transistor T5, a first capacitor C1, a second capacitor C2 and a light emitting element EE.

The first transistor T1 may include a control electrode connected to the first node N1, a first electrode connected to a second node N2 and a third node N3 connected to a second electrode. In an embodiment, the first transistor T1 may further include a second control electrode, which receives the first power voltage ELVDD. The first transistor T1 may generate a driving current based on a voltage of the first node N1. The first transistor T1 may output the driving current based on the voltage of the first node N1. For example, the first transistor T1 may be called as a driving transistor.

The second transistor T2 may include a control electrode, which receives the write gate signal GW[n], a first electrode, which receives the data voltage VDATA and a second electrode connected to the first node N1. In an embodiment, the second transistor T2 may further include a second control electrode, which receives the first power voltage ELVDD. The second transistor T2 may apply the data voltage VDATA to the first node N1 in response to the write gate signal GW[n]. For example, the second transistor T2 may be called as a write transistor.

The third transistor T3 may include a control electrode, which receives the emission signal EM[n], a first electrode, which receives the first power voltage ELVDD and a second electrode connected to the second node N2. In an embodiment, the third transistor T3 may further include a second control electrode, which receives the first power voltage ELVDD. The third transistor T3 may apply the first power voltage ELVDD to the second node N2 in response to the emission signal EM[n]. For example, the third transistor T3 may be called as an emission transistor.

The fourth transistor T4 may include a control electrode, which receives the reset signal RES[n], a first electrode connected to the third node N3 and a second electrode connected to the fourth node N4. In an embodiment, the fourth transistor T4 may further include a second control electrode, which receives the first power voltage ELVDD. The fourth transistor T4 may connect the third node N3 and the fourth node N4 in response to the reset signal RES[n]. For example, the fourth transistor T4 may be called as a load transistor.

The fifth transistor T5 may include a control electrode, which receives the bias signal EB[n], a first electrode, which receives an initialization voltage VINT and a second electrode connected to the fourth node N4. In an embodiment, the fifth transistor T5 may further include a second control electrode, which receives the first power voltage ELVDD. The fifth transistor T5 may apply the initialization voltage VINT to the fourth node N4 in response to the bias signal EB[n]. For example, the fifth transistor T5 may be called as an initialization transistor.

The first capacitor C1 may include a first electrode connected to the second node N2 and a second electrode connected to the first node N1. The second capacitor C2 may include a first electrode connected to the first node N1 and a second electrode, which receives a reference voltage VREF.

The light emitting element EE may include a first electrode connected to the fourth node N4 and a second electrode, which receives a second power voltage ELVSS. For example, the light emitting element EE may be a light emitting diode. In an embodiment, the light emitting element EE may be a micro light emitting diode. However, the present invention is not limited to the type of the light emitting element EE.

In an embodiment, the pixel circuit PXA[n] may not include a capacitor connected between the first node N1 and the fourth node N4. Accordingly, a deterioration of the pixel circuit PXA[n] may be reduced. Additionally, an integration of the pixel circuit PXA[n] may be improved.

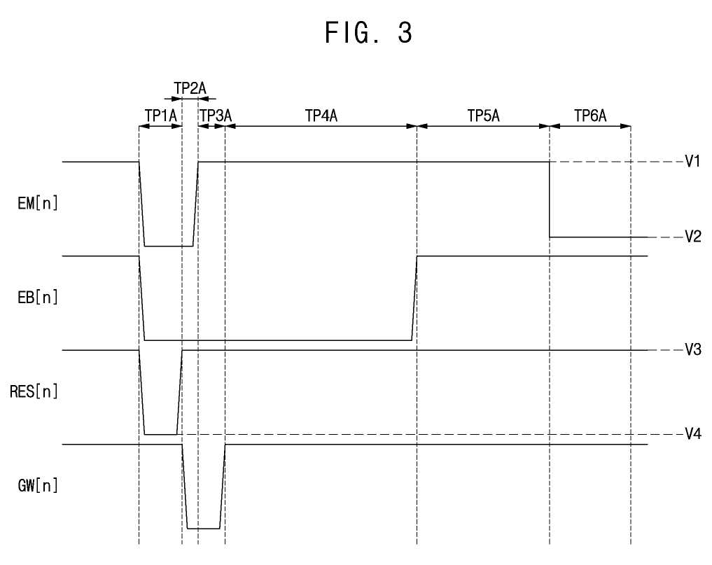

FIG. 3 is a timing diagram illustrating an example of signal applied to a pixel circuit PXA[n] of FIG. 2.

Referring to FIG. 1 to FIG. 3, a frame period in which the pixel circuit PXA[n] is driven may include a first period TP1A, a second period TP2A, a third period TP3A, a fourth period TP4A, a fifth period TP5A and a sixth period TP6A.

In the present embodiment, an activation level may mean a voltage level which turns on a transistor. For example, the activation level may mean a voltage level at which the transistor is strongly turned on. When the transistor is strongly turned on, the transistor may operate in a saturation region. For example, when the transistor is a P-type transistor, the activation level may be a logic low level. For example, when the transistor is an N-type transistor, the activation level may be a logic high level. An inactivation level may mean a voltage level which turns off the transistor. For example, when the transistor is a P-type transistor, the inactivation level may be a logic high level. For example, when the transistor is an N-type transistor, the inactivation level may be a logic low level.

In the first period TP1A, the emission signal EM[n] may have a second voltage level V2, the bias signal EB[n] may have an activation level, the reset signal RES[n] may have a fourth voltage level V4, and the write gate signal GW[n] may have an inactivation level. The second voltage level V2 may be an activation level. The fourth voltage level V4 may be an activation level. In an embodiment, the fourth voltage level V4 may be lower than the second voltage level V2. For example, the first period TP1A may be called as an “initialization period”.

In the second period TP2A, the emission signal EM[n] may be changed from the second voltage level V2 to a first voltage level V1, the bias signal EB[n] may have an activation level, the reset signal RES[n] may have a third voltage level V3, and the write gate signal GW[n] may be changed from an inactivation level to an activation level. The third voltage level V3 may be lower than the first voltage level V1. The third voltage level V3 may be a voltage level which weakly turns on the fourth transistor T4. When the transistor is weakly turned on, the transistor may operate in a linear region. When the transistor is weakly turned on, the transistor may operate as a resistor.

In the third period TP3A, the emission signal EM[n] may have the first voltage level V1, the bias signal EB[n] may have an activation level, the reset signal RES[n] may have the third voltage level V3, and the write gate signal GW[n] may have an activation level. A write period may include the second period TP2A and the third period TP3A.

In the fourth period TP4A, the emission signal EM[n] may have the first voltage level V1, the bias signal EB[n] may have an activation level, the reset signal RES[n] may have the third voltage level V3, and the write gate signal GW[n] may have an inactivation level.

In the fifth period TP5A, the emission signal EM[n] may have the first voltage level V1, the bias signal EB[n] may have an inactivation level, the reset signal RES[n] may have the third voltage level V3, and the write gate signal GW[n] may have an inactivation level.

In the sixth period TP6A, the emission signal EM[n] may have the second voltage level V2, the bias signal EB[n] may have an inactivation level, the reset signal RES[n] may have the third voltage level V3, and the write gate signal GW[n] may have an inactivation level. For example, the sixth period TP6A may be called as an “emission period”.

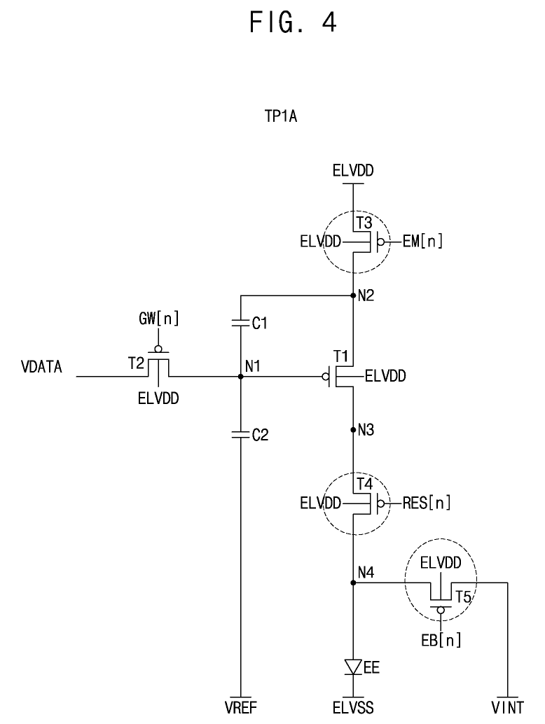

FIG. 4 is a circuit diagram illustrating an operation of a pixel circuit PXA[n] of FIG. 2 in a first period TP1A of FIG. 3.

Referring to FIG. 1 to FIG. 3, in the first period TP1A, the third transistor T3 may be turned on in response to the emission signal EM[n]. Since the third transistor T3 may be turned on, the first power voltage ELVDD may be applied to the second node N2. In the first period TP1A, the second node N2 may be initialized as the first power voltage ELVDD. For example, in the first period TP1A, the first electrode of the first transistor T1 may be initialized as the first power voltage ELVDD.

In the first period TP1A, the fifth transistor T5 may be turned on in response to the bias signal EB[n]. Since the fifth transistor T5 may be turned on, the initialization voltage VINT may be applied to the fourth node N4. Additionally, in the first period TP1A, the fourth transistor T4 may be turned on in response to the reset signal RES[n]. Since the fourth transistor T4 may be turned on, the third node N3 and the fourth node N4 may be connected. In the first period TP1A, the fourth transistor T4 and the fifth transistor T5 may be turned on, so that the initialization voltage VINT may be applied to the third node N3. For example, in the first period TP1A, the third node N3 may be initialized as the initialization voltage VINT. For example, in the first period TP1A, the second electrode of the first transistor T1 may be initialized as the initialization voltage VINT. In the first section TP1A, since the second electrode of the first transistor T1 may be initialized with the initialization voltage VINT, a black characteristic of the pixel circuit PXA[n] may be effectively improved. For example, when the pixel circuit PXA[n] displays black, the second electrode of the first transistor T1 may be initialized as the initialization voltage VINT, so that a luminance of the pixel circuit PXA[n] may be about 0 nit. Accordingly, the black characteristic of the pixel circuit PXA[n] may be effectively improved.

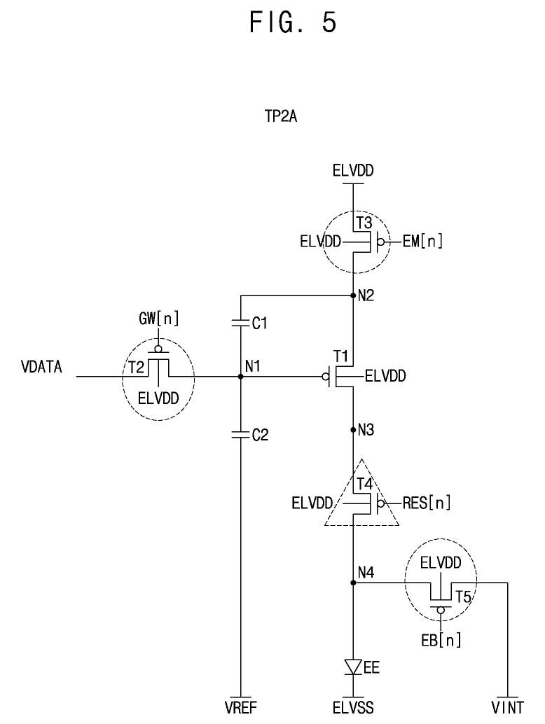

FIG. 5 is a circuit diagram illustrating an operation of a pixel circuit PXA[n] of FIG. 2 in a second period TP2A of FIG. 3.

Referring to FIG. 1 to FIG. 3 and FIG. 5, in the second period TP2A, the second transistor T2 may be turned on in response to the write gate signal GW[n]. Since the second transistor T2 may be turned on, the data voltage VDATA may be applied to the first node N1. In the second period TP2A, the first power voltage ELVDD may be applied to the second node N2 in response to the emission signal EM[n]. In the second period TP2A, the fourth transistor T4 may be weakly turned on. Additionally, in the second period TP2A, the fifth transistor T5 may be turned on. Accordingly, in the second period TP2A, the initialization voltage VINT may be applied to the third node N3.

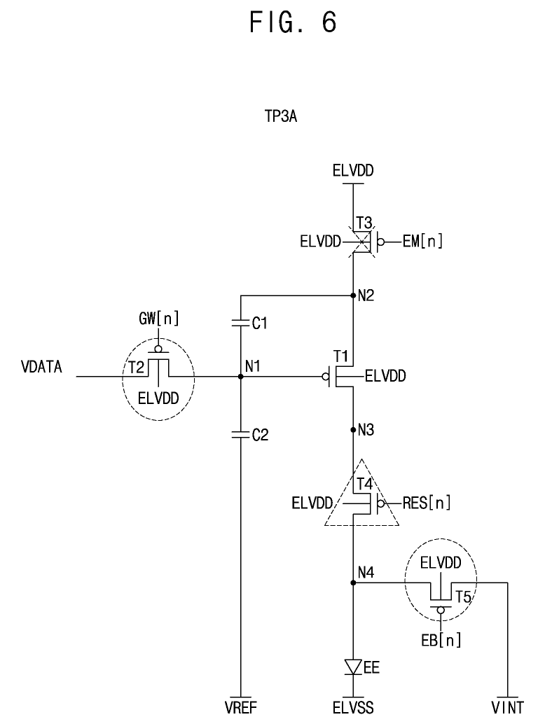

FIG. 6 is a circuit diagram illustrating an operation of a pixel circuit PXA[n] of FIG. 2 in a third period TP3A of FIG. 3.

Referring to FIG. 1 to FIG. 3 and FIG. 6, in the third period TP3A, the second transistor T2 may be turned on in response to the write gate signal GW[n]. Since the second transistor T2 may be turned on, the data voltage VDATA may be applied to the first node N1. Additionally, in the third period TP3A, the third transistor T3 may be turned off in response to the emission signal EM[n]. Accordingly, in the third period TP3A, a voltage of the second node N2 may be a voltage obtained by subtracting the threshold voltage of the first transistor T1 from the voltage of the first node N1 (e.g., the data voltage VDATA). For example, in the third period TP3A, the voltage of the first node N1 may be lowered along a path formed through the first transistor T1, the fourth transistor T4, and the fifth transistor T5. Accordingly, in the third period TP3A, the voltage of the second node N2 may be a voltage obtained by subtracting the threshold voltage of the first transistor T1 from the voltage of the first node N1 (e.g., the data voltage VDATA).

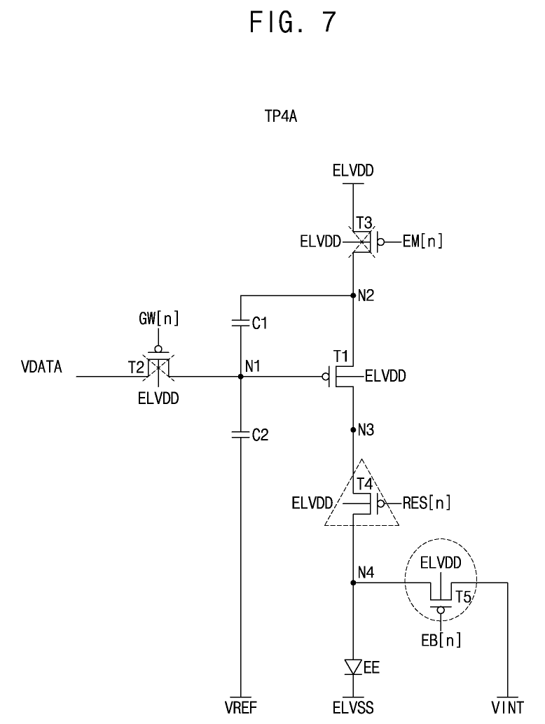

FIG. 7 is a circuit diagram illustrating an operation of a pixel circuit PXA[n] of FIG. 2 in a fourth period TP4A of FIG. 3.

Referring to FIG. 1 to FIG. 3 and FIG. 7, in the fourth period TP4A, the second transistor T2 may be turned off in response to the write gate signal GW[n]. In the fourth period TP4A, since the second transistor T2 may be turned off, the first node N1 may be floated.

In the fourth period TP4A, the reset signal RES[n] may have the third voltage level V3, and the bias signal EB[n] may have an activation level. Accordingly, in the fourth period TP4A, the fourth transistor T4 and the fifth transistor T5 may be turned on. In the fourth period TP4A, the fourth transistor T4 and the fifth transistor T5 may be turned on, so that the third node N3 may be initialized as the initialization voltage VINT. Additionally, in the fourth period TP4A, the fourth transistor T4 may be weakly turned on, so that the voltage of the third node N3 may be gradually changed. Accordingly, an influence of coupling by the first transistor T1 between the first node N1 and the third node N3 may be reduced. Accordingly, an emission reliability of the pixel circuit PXA[n] may be further improved. For example, the fourth period TP4A may be called as a “second initialization period”.

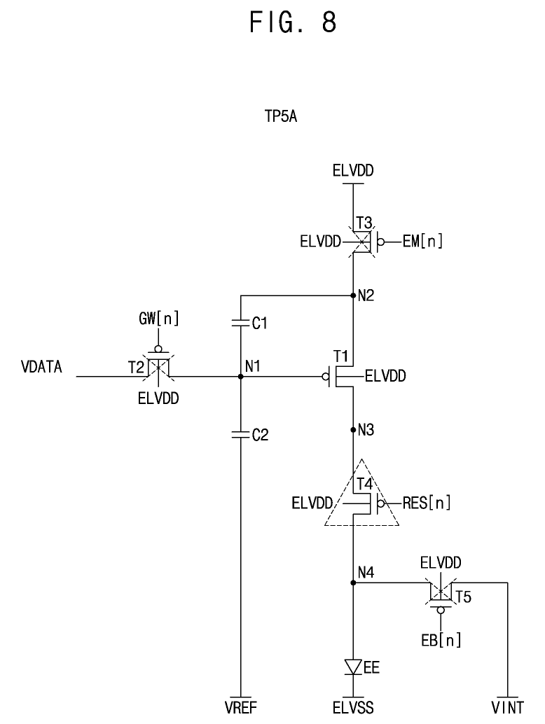

FIG. 8 is a circuit diagram illustrating an operation of a pixel circuit PXA[n] of FIG. 2 in a fifth period TP5A of FIG. 3.

Referring to FIG. 1 to FIG. 3 and FIG. 8, in the fifth period TP5A, the bias signal EB[n] may have an inactivation level. Accordingly, in the fifth period TP5A, the fifth transistor T5 may be turned off. For example, the fifth period TP5A may be named an emission waiting period. In an embodiment, a frame period in which the pixel circuit PXA[n] is driven may not include the fifth period TP5A.

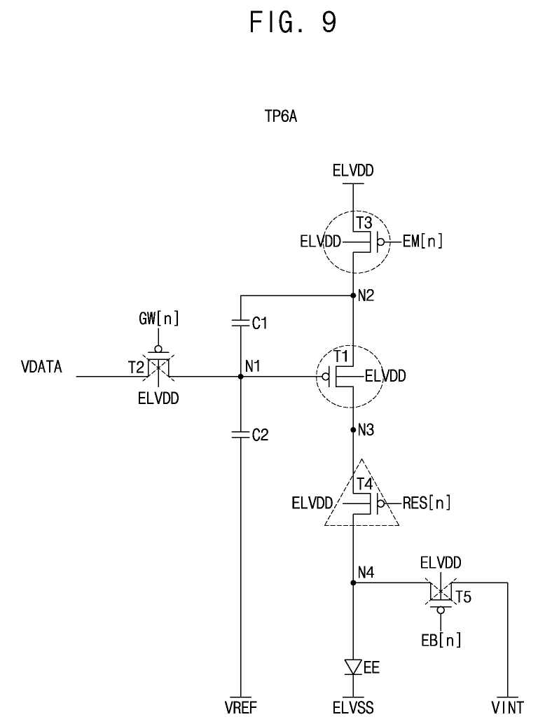

FIG. 9 is a circuit diagram illustrating an operation of a pixel circuit PXA[n] of FIG. 2 in a sixth period TP6A of FIG. 3.

Referring to FIG. 1 to FIG. 3 and FIG. 9, in the sixth period TP6A, the emission signal EM[n] may have the second voltage level V2. In the sixth period TP6A, the third transistor T3 may be turned on in response to the emission signal EM[n]. In the sixth period TP6A, the third transistor T3 may be turned on in response to the emission signal EM[n], so that the first power voltage ELVDD may be applied to the second node N2. The first capacitor C1 may couple a voltage change of the second node N2 and apply a coupling voltage corresponding to the change to the first node N1. For example, the coupling voltage may have a value based on the first power voltage ELVDD, the data voltage VDATA, the threshold voltage of the first transistor T1, a capacitance of the first capacitor C1, and a capacitance of the second capacitor C2. For example, in the pixel circuit PXA[n], the threshold voltage of the first transistor T1 may be compensated based on a source-follower operation. Accordingly, the emission reliability of the pixel circuit PXA[n] may be effectively improved.

In the sixth period TP6A, the first transistor T1 may generate a driving current. In the sixth period TP6A, since the reset signal RES[n] may have the third voltage level V3, the fourth transistor T4 may be weakly turned on. In the sixth period TP6A, since the fourth transistor T4 may be weakly turned on, the black characteristic of the pixel circuit PXA[n] may be effectively improved. Additionally, in the sixth period TP6A, the fifth transistor T5 may be turned off in response to the bias signal EB[n]. Accordingly, the driving current may be applied to the light emitting element EE. In the sixth section TP6A, the light emitting element EE may emit light based on the driving current. For example, the sixth period TP6A may be called as an emission period.

In the present embodiment, the reset signal RES[n] may toggle between the third voltage level V3 and the fourth voltage level V4. Since the reset signal RES[n] may have the fourth voltage level V4 in the initialization period, the fourth transistor T4 may be turned on (e.g., strongly turned on) in the initialization period. Accordingly, the reliability of an initialization operation in which the third node N3 is initialized as the initialization voltage VINT may be improved. Accordingly, the emission reliability of the pixel circuit PXA[n] may be effectively improved.

Additionally, in the emission period, since the fourth transistor T4 may be weakly turned on, the fourth transistor T4 may operate as a resistor. Accordingly, when the pixel circuit PXA[n] displays black, the driving current applied to the fourth node N4 may be further reduced. Accordingly, the black characteristic of the pixel circuit PXA[n] may be effectively improved.

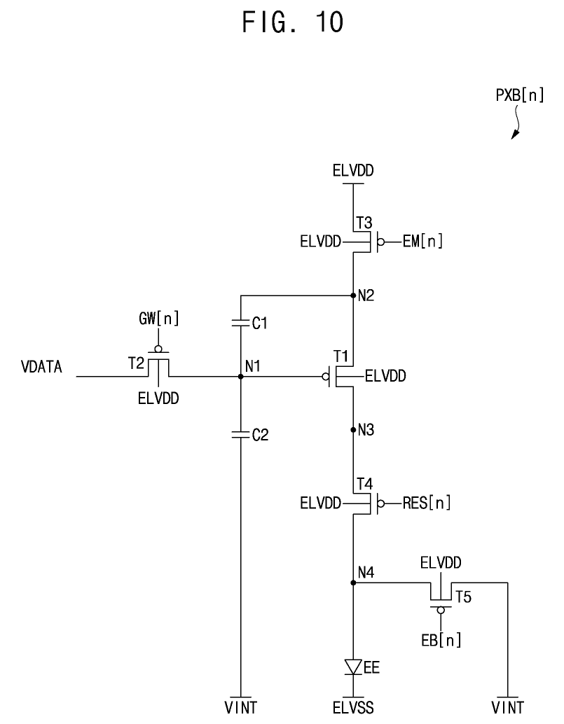

FIG. 10 is a circuit diagram illustrating an example of a pixel circuit PX included in a display device 1 of FIG. 1.

Referring to FIG. 10, a pixel circuit PXB[n] may include the first transistor T1, the second transistor T2, the third transistor T3, the fourth transistor T4, the fifth transistor T5, the first capacitor C1, the second capacitor C2 and the light emitting element EE.

The pixel circuit PXB[n] of FIG. 10 is substantially same as the pixel circuit PXA[n] of FIG. 2 except that the second electrode of the second capacitor C2 receives the initialization voltage VINT, so that the same reference numerals will be used and any repetitive explanation concerning the above elements will be omitted.

In the present embodiment, the reset signal RES[n] may toggle between the third voltage level V3 and the fourth voltage level V4. Since the reset signal RES[n] may have the fourth voltage level V4 in the initialization period, the fourth transistor T4 may be turned on (e.g., strongly turned on) in the initialization period. Accordingly, the reliability of an initialization operation in which the third node N3 is initialized as the initialization voltage VINT may be improved. Accordingly, the emission reliability of the pixel circuit PXB[n] may be effectively improved.

Additionally, in the emission period, since the fourth transistor T4 may be weakly turned on, the fourth transistor T4 may operate as a resistor. Accordingly, when the pixel circuit PXB[n] displays black, the driving current applied to the fourth node N4 may be further reduced. Accordingly, the black characteristic of the pixel circuit PXB[n] may be effectively improved.

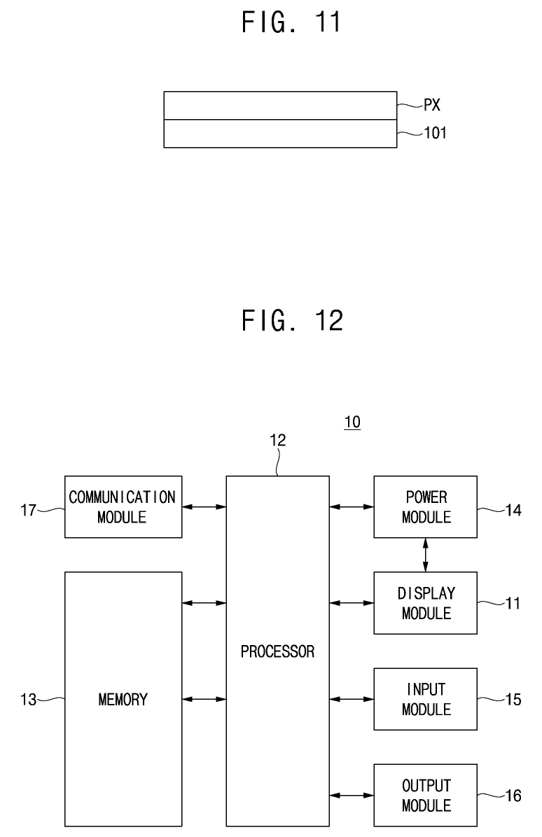

FIG. 11 is a diagram illustrating an example of a pixel circuit PX included in a display device 1 of FIG. 1 is located on a substrate 101.

Referring to FIG. 1 and FIG. 11, the pixel circuit PX may be located (or disposed) on a substrate 101. In an embodiment, the substrate 101 may be a silicon-based substrate. In an embodiment, the pixel circuit PX may be located on a silicon-based substrate.

The silicon-based substrate may include a single-crystal silicon wafer, a polycrystalline silicon wafer, or an amorphous silicon wafer. A semiconductor layer may be formed on the silicon-based substrate through a semiconductor process. For example, the silicon substrate on which the semiconductor layer is formed may be a silicon semiconductor substrate.

In an embodiment, the semiconductor layer may be formed on the silicon-based substrate through a Complementary Metal Oxide Semiconductor (CMOS) process. The semiconductor layer may include a pixel circuit in the form of a CMOS. For example, the pixel circuit PX may include a CMOS circuit including a P-type transistor and an N-type transistor. Accordingly, the display device 1 may be a display-on-silicon (DOS), or Light Emitting Diode on Silicon (LEDoS) having a light emitting structure on a silicon semiconductor substrate.

Since the pixel PX may be located on a silicon-based substrate, the voltage levels of input signals applied to the pixel PX may be set more precisely. Additionally, since the pixel PX may be located on a silicon-based substrate, at least one of the transistors included in the pixel PX may be a MOS (Metal Oxide Semiconductor) transistor. Accordingly, a driving stability of the at least one transistor may be improved. Accordingly, the driving stability and emission reliability of the pixel PX may be effectively improved.

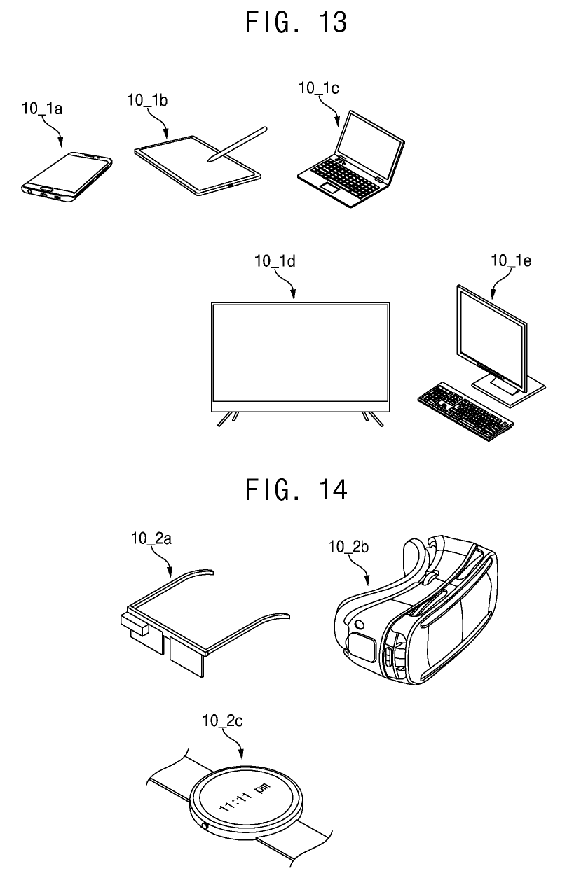

FIG. 12 is a block diagram illustrating an electronic device 10 according to embodiments of the present invention.

Referring to FIG. 12, an electronic device 10 according to an embodiment may include a display module 11, a processor 12, a memory 13 and a power module 14.

The processor 12 may include at least one of a central processing unit (CPU), an application processor (AP), a graphic processing unit (GPU), a communication processor (CP), an image signal processor (ISP), and a controller.

The memory 13 may store data information for the operation of the processor 12 or the display module 11. When the processor 12 executes an application stored in the memory 13, an image data signal and/or an input control signal is transmitted to the display module 11, and the display module 11 may process the received signal and output image information through a display screen.

The power module 14 may include a power supply module, such as a power adapter or a battery device, and a power conversion module which converts power supplied by the power supply module to generate power for the operation of the electronic device 10.

The electronic device 10 may further include an input module 15, a non-image output module 16 and/or a communication module 17.

The input module 15 may provide input information to the processor 12 and/or the display module 11. The input module 15 may include various sensor modules as well as physical buttons, a keyboard, and a microphone. Examples of the sensor modules may include a touch sensor, a pressure sensor, a distance sensor, a position sensor, a digitizer, a motion recognition sensor, a camera sensor, a light receiving sensor, a photoelectric conversion sensor, a temperature sensor, and a biosensor such as a blood pressure sensor, a blood sugar sensor, an electrocardiogram sensor, and a heart rate sensor.

The non-image output module 16 may receive information other than images from the processor 12 and provide the information to the user. Examples of the non-image output module 16 may include an audio module, a haptic module, a light-emitting module, etc., and may include other functional modules unique to electronic devices (e.g., a cooling module of a refrigerator, etc.).

The communication module 17 may be a module that is responsible for transmitting and receiving information between the electronic device 10 and an external device, and may include a receiving unit and a transmitting unit. The communication module 17 may include various wireless communication modules such as a mobile communication module, a Wi-Fi module, a Bluetooth module, or various wired communication modules.

At least one of the components of the electronic device 10 described above may be included in the display device according to the embodiments described above. Additionally, some of the individual modules functionally included in one module may be included in the display device, and other may be provided separately from the display device. For example, the display device may include the display module 11, and the processor 12, the memory 13, and the power module 14 may be provided in the form of other devices within the electronic device 10 other than the display device.

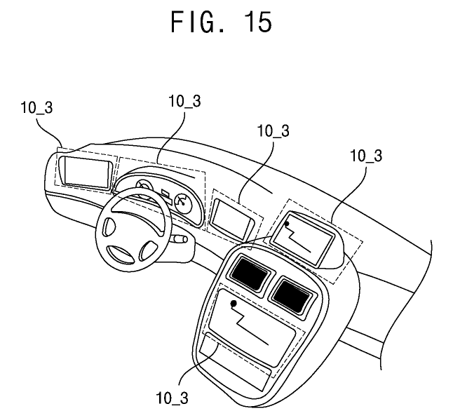

FIG. 13 to FIG. 15 are schematic diagrams illustrating an electronic device according to embodiments.

Referring to FIG. 13, a smartphone 10_1a, a tablet PC 10_1b, a laptop 10_1c, a TV 10_1d, and a desk monitor 10_1e are examples of electronic devices.

The smartphone 10_1a may include an input module such as a touch sensor and a communication module in addition to the display module 11. The smartphone 10_1a may process information received through the communication module or other input modules and display the information through the display module of the display device.

In the case of tablet PC 10_1b, laptop 10_1c, TV 10_1d, and desk monitor 10_1e, may include a display module and an input module similar to the smartphone 10_1a, and in some cases, may further include a communication module.

Referring to FIG. 14, an electronic device including a display module may be applied to a wearable electronic device. The wearable electronic device may be a smart glasses 10_2a, a head mounted display 10_2b, a smart watch 10_2c, etc.

The smart glasses 10_2a and head mounted displays 10_2b may include a display module which emits a display image and a reflector which reflects the emitted display image and provides it to the user's eyes, thereby providing a virtual reality or augmented reality screen to the user.

The smartwatch 10_2c may include a biometric sensor as an input device and may provide biometric information recognized by the biometric sensor to the user through a display module.

Referring to FIG. 15, an electronic device including a display module may be applied to a vehicle. For example, the electronic device 10_3 may be applied to a dashboard, center fascia, etc. of a vehicle, or may be applied to a CID (Center Information Display) placed on a dashboard of a vehicle or a room mirror display replacing a side mirror.

Although not illustrated, electronic devices to which the display device according to the embodiments is applied may include not only devices that mainly display screens, such as billboards, electronic boards, and game consoles, but also various home appliances that display information through display modules, such as refrigerators, washing machines, dryers, air conditioners, and robot vacuum cleaners. Additionally, when the display module has a function of transmitting light, it may be applied to electronic devices, such as smart windows or transparent display devices that display a background and a display image together. The type of electronic device according to the embodiment is not limited by the examples, and application to other various electronic devices that are not illustrated may also be possible.

The display device according to the embodiments may be applied to a display device included in a computer, a notebook, a mobile phone, a smart phone, a smart pad, a PMP, a PDA, an MP3 player, or the like.

The foregoing is illustrative of the present invention and is not to be construed as limiting thereof. Although a few embodiments of the present invention have been described, those skilled in the art will readily appreciate that many modifications are possible in the embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A pixel circuit comprising:
a first transistor including a control electrode connected to a first node, a first electrode connected to a second node and a second electrode connected to a third node;
a second transistor, which applies a data voltage to the first node in response to a write gate signal;
a third transistor, which applies a first power voltage to the second node in response to an emission signal;
a fourth transistor, which connects the third node and a fourth node in response to a reset signal;
a fifth transistor, which applies an initialization voltage to the fourth node in response to a bias signal; and
a light emitting element including a first electrode connected to the fourth node and a second electrode, which receives a second power voltage,
wherein the emission signal toggles between a first voltage level and a second voltage level,
wherein the first voltage level is higher than the second voltage level,
wherein the reset signal toggles between a third voltage level and a fourth voltage level,
wherein the third voltage level is higher than the fourth voltage level, and
wherein the third voltage level is lower than the first voltage level.

2. The pixel circuit of claim 1, wherein the third voltage level is a voltage such that the fourth transistor is weakly turned on so that the fourth transistor operates in a linear region.

3. The pixel circuit of claim 1, wherein in an emission period in which the light emitting element emits, the fourth transistor is weakly turned on.

4. The pixel circuit of claim 3, wherein in the emission period, the fourth transistor operates in a linear region.

5. The pixel circuit of claim 1, wherein a frame period in which the pixel circuit is driven includes an initialization period, a write period following the initialization period, and an emission period following the write period, and
wherein in the initialization period, the reset signal has the fourth voltage level, the emission signal has the second voltage level and the bias signal has an activation level.

6. The pixel circuit of claim 5, wherein in the initialization period, the fourth transistor is turned on, and the fifth transistor is turned on.

7. The pixel circuit of claim 5, wherein in in the write period, the emission signal is changed from the second voltage level to the first voltage level, the reset signal has the third voltage level, and the write gate signal has an activation level.

8. The pixel circuit of claim 7, wherein in emission period, the emission signal has the second voltage level, and the reset signal has the third voltage level.

9. The pixel circuit of claim 1, wherein a frame period in which the pixel circuit is driven includes a first to sixth periods, and
wherein in the first period, the emission signal has the second voltage level, the bias signal has an activation level, and the reset signal has the fourth voltage level.

10. The pixel circuit of claim 9, wherein in the second period, which follows the first period, the emission signal is changed from the second voltage level to the first voltage level, the bias signal has the activation level, and the reset signal has the third voltage level.

11. The pixel circuit of claim 10, wherein in the third period, which follows the second period, the emission signal has the first voltage level, the bias signal has the activation level, and the write gate signal has an activation level.

12. The pixel circuit of claim 11, wherein in the fourth period, which follows the third period, the bias signal has the activation level, and the write gate signal has an inactivation level.

13. The pixel circuit of claim 12, wherein in the fifth period, which follows the fourth period, the bias signal has an inactivation level.

14. The pixel circuit of claim 11, wherein in the sixth period, which follows the fifth period, the emission signal has the second voltage level, and the reset signal has the third voltage level.

15. The pixel circuit of claim 1, wherein the second transistor includes a control electrode, which receives the write gate signal, a first electrode, which receives the data voltage and a second electrode connected to the first node,
wherein the third transistor includes a control electrode, which receives the emission signal, a first electrode, which receives the first power voltage and a second electrode connected to the second node,
wherein the fourth transistor includes a control electrode, which receives the emission signal, a first electrode connected to the third node and a second electrode connected to the fourth node, and
wherein the fifth transistor includes a control electrode, which receives the bias signal, a first electrode, which receives the initialization voltage and a second electrode connected to the fourth node.

16. The pixel circuit of claim 1, further comprising:
a first capacitor including a first electrode connected to the second node and a second electrode connected to the first node; and
a second capacitor including a first electrode connected to the first node and a second electrode, which receives a reference voltage.

17. The pixel circuit of claim 16, wherein the reference voltage is the initialization voltage.

18. A display device comprising:
a display panel including a pixel circuit;
a gate driver, which outputs a gate signal including a write gate signal to the pixel circuit;
an emission driver, which outputs an emission signal to the pixel circuit;
a data driver, which applies a data voltage to the pixel circuit; and
a driving controller, which controls the gate driver, the emission driver and the data driver,
wherein the pixel circuit includes:
a first transistor including a control electrode connected to a first node, a first electrode connected to a second node and a second electrode connected to a third node;
a second transistor, which applies the data voltage to the first node in response to the write gate signal;
a third transistor, which applies a first power voltage to the second node in response to the emission signal;
a fourth transistor, which connects the third node and a fourth node in response to a reset signal;
a fifth transistor, which applies an initialization voltage to the fourth node in response to a bias signal; and
a light emitting element including a first electrode connected to the fourth node and a second electrode, which receives a second power voltage,
wherein the emission signal toggles between a first voltage level and a second voltage level,
wherein the first voltage level is higher than the second voltage level,
wherein the reset signal toggles between a third voltage level and a fourth voltage level,
wherein the third voltage level is higher than the fourth voltage level, and
wherein the third voltage level is lower than the first voltage level.

19. The display device of claim 18, wherein the third voltage level is a voltage such that the fourth transistor is weakly turned on.

20. An electronic device comprising:
a display panel including a pixel circuit;
a gate driver, which outputs a gate signal including a write gate signal to the pixel circuit;
an emission driver, which outputs an emission signal to the pixel circuit;
a data driver, which applies a data voltage to the pixel circuit;
a driving controller, which controls the gate driver, the emission driver and the data driver based on an input control signal; and
a processor, which outputs the input control signal,
wherein the pixel circuit includes:
a first transistor including a control electrode connected to a first node, a first electrode connected to a second node and a second electrode connected to a third node;
a second transistor, which applies the data voltage to the first node in response to the write gate signal;
a third transistor, which applies a first power voltage to the second node in response to the emission signal;
a fourth transistor, which connects the third node and a fourth node in response to a reset signal;
a fifth transistor, which applies an initialization voltage to the fourth node in response to a bias signal; and
a light emitting element including a first electrode connected to the fourth node and a second electrode, which receives a second power voltage,
wherein the emission signal toggles between a first voltage level and a second voltage level,
wherein the first voltage level is higher than the second voltage level,
wherein the reset signal toggles between a third voltage level and a fourth voltage level,
wherein the third voltage level is higher than the fourth voltage level, and
wherein the third voltage level is lower than the first voltage level.
